(19) United States
(12) Patent Application Publication
(10) Pub. No.: US 2003/0177826 A1
(43) Pub. Date: Sep. 25, 2003

(54) Liquid nitrogen level sensor-monitor device using high Tc superconductors and method of manufacture thereof

(76) Inventors: Sobha Adkadkam, Kerala (IN); Rajappan Padmavathy Aloysius, Kerala (IN); Perumal Guruswamy, India (IN); Krishna Gopakumar Warrier, India (IN); Upendran Syamaprasad, India (IN)

Correspondence Address: NIXON & VANDERHYE P.C., 8th Floor, 1100 North Glebe Road, Arlington, VA, 22201, US

(21) Appl. No.: 10/101,528

(22) Filed: Mar. 20, 2002

(51) Int. Cl. G01F 23/00

(52) U.S. Cl. 73/304 C

(57) ABSTRACT

The present invention provides a novel liquid nitrogen level sensing-monitoring device comprising a sensor element made of a high temperature conducting material encapsulated in a layer of metal, said encapsulated sensor element being affixed to a cryostable fiber reinforced plastic substrate, said sensor element being provided with a resistance measuring means and a method for the manufacture thereof.

### FIELD OF THE INVENTION

The present invention relates to a liquid level sensor-monitor device using high Tc superconductors. More particularly, the present invention relates to a liquid nitrogen level sensor-monitor device using high Tc superconductors and useful in the accurate monitoring the level of liquid nitrogen in cryocans, storage tanks, laboratory experimental set-ups, on board space vehicles and a variety of other cryogenic instruments. The present invention also relates to a method for the manufacture of liquid nitrogen level sensor-monitor devices. More particularly, the present invention also relates to a method for the manufacture of liquid nitrogen level sensor-monitor device using high Tc superconductors and useful in the accurate monitoring the level of liquid nitrogen in cryocans, storage tanks, laboratory experimental set-ups, on board space vehicles and a variety of other cryogenic instruments.

### BACKGROUND OF THE INVENTION

In hitherto known liquid nitrogen level sensors/monitors, cryogen level is monitored by measuring either change in resistance or capacitance of a continuous resistive element or a long co-axial capacitor. It is also known to use the difference in electrical characteristics of electronic components such as diodes stacked in a linear array to sense and monitor the liquid nitrogen level. However, since the normal variation of electrical properties of sensor elements known in the art with temperature is not significant, the sensitivity of measurement using traditional resistive and capacitative methods is limited. It is difficult to monitor the level continuously or periodically in cases where stacked elements are used. Another disadvantage of prior art devices is that thermal mass of conventional sensor elements and associated gadgets often becomes large due to their large size leading to greater loss of expensive cryogen and longer time to obtain a stable reading.

It is therefore important to provide cryogen level monitoring and sensing devices which overcome the problems of loss of cryogen, lack of stability in readings, that are associated with the prior art devices.

### OBJECTS OF THE INVENTION

The main object of the invention is to provide a novel device for cryogen level sensing and monitoring that ensures stable readings.

Another object of the invention is to provide a novel device for cryogen level sensing and monitoring that is easy to use and efficient and does not result in any loss of cryogen.

It is another object of the present invention to provide a liquid nitrogen level sensing-monitoring assembly using high Tc superconductors that overcomes the problem of lack of stability and loss of cryogen associated with the prior art.

### SUMMARY OF THE INVENTION

Accordingly, the present invention provides a novel liquid nitrogen level sensing-monitoring device comprising a sensor element made of a high temperature conducting material encapsulated in a layer of metal, said encapsulated sensor element being affixed to a cryostable fiber reinforced plastic substrate, said sensor element being provided with a resistance measuring means.

In one embodiment of the invention, the sensor element is a thin tape or filament.

In another embodiment of the invention, the sensor element tape comprises a tape made of one or more filaments.

In a further embodiment of the invention, the high temperature conducting material is selected from BSCCO and YBCO.

In another embodiment of the invention, the metal layer comprises a thin layer of silver or a silver alloy.

In another embodiment of the invention, the fiber reinforced substrate is a long strip.

In another embodiment of the invention, resistance measuring means comprises a four terminal resistance measuring means, one terminal each being connected to respective ends of the encapsulated sensor element as the current terminals and the other two terminals being provided on the inside from both ends as the voltage terminals for measuring the resistance.

In a further embodiment of the invention, the resistance measuring means is connected to a constant current source and a sensitive voltmeter calibrated in terms of liquid nitrogen level.

The present invention also provides a method for the manufacture of liquid nitrogen level sensing-monitoring device comprising packing a highly reactive precursor powder free from carbon in high purity seamless silver tubes, end sealing the silver tubes containing the precursor, repeatedly groove rolling and annealing the silver tubes to form silver sheathed wires, repeatedly flat rolling and annealing the wires to form silver sheathed tapes, repeatedly flat rolling and heat treating the tapes at a temperature in the range of 810 to 840° C. in an oxidising atmosphere for a period in the range of 100 to 150 hours to obtain silver sheathed mono layer superconducting tape.

In one embodiment of the invention, a plurality of mono layer superconducting tape are stacked and folded in silver sheets of high purity and then repeatedly annealed and flat rolled to form multilayered tapes which are then heat treated at a temperature in the range of 810 to 840° C. in an oxidising atmosphere for a period in the range of 100 to 150 hours to obtain silver sheathed multilayer superconducting tape.

In one embodiment of the invention, the number of monolayer tapes stacked are in the range of 5 to 20.

In another embodiment of the invention, the thickness of the multilayer superconducting tape is in the range of 0.25 to 1.5 mm.

In one embodiment of the invention, the sensor element is a thin tape or filament.

In another embodiment of the invention, the sensor element tape comprises a tape made of one or more filaments.

In a further embodiment of the invention, the high temperature conducting material is selected from BSCCO and YBCO.

In another embodiment of the invention, the precursor powder comprises a stoichiometry of Bi:Pb:Sr:Ca:Cu of 1.5-1.9:0.3-0.5:1.8-2.3:2-2.5:2.5-3.8.

In another embodiment of the invention, the metal layer comprises a thin layer of silver or a silver alloy.

In another embodiment of the invention, the fiber reinforced substrate is a long strip.

### BRIEF DESCRIPTION OF THE ACCOMPANYING DRAWINGS

FIG. 1 is a schematic representation of the liquid nitrogen level sensor-monitor device of the invention.

FIG. 2 is a graph of the liquid nitrogen level vis-à-vis resistance measured using the device of the invention (example 1).

### DETAILED DESCRIPTION OF THE INVENTION

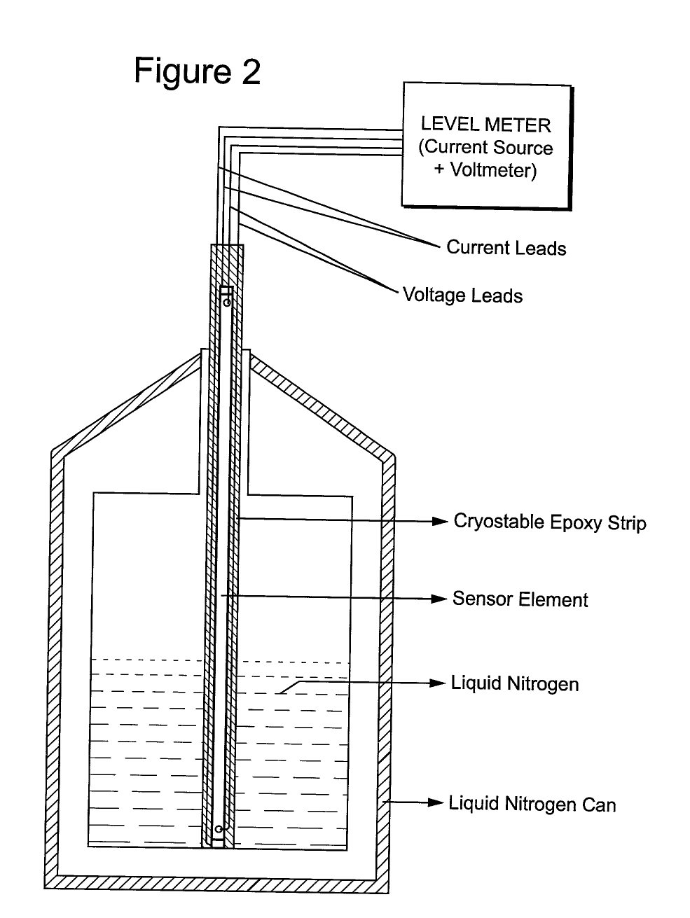

The device of the invention utilizes a sensor element made of a high temperature superconducting material such as BSCCO in the form of a very thin tape or a filament encapsulated in a very thin layer of a metal such as silver or a silver based alloy. The resistance of the superconductor based sensor element is measured accurately by a four terminal method by passing a constant current through the two outer terminals and measuring the voltage generated across the two inner terminals. Since the portion of the element in liquid nitrogen becomes superconducting and loses its resistance, the resulting resistance of the element gives a measure of the portion of the element above the liquid nitrogen. Thus the liquid nitrogen level at any given point of time can be determined by the plot of the resistance versus liquid nitrogen level (FIG. 2).

This method is highly sensitive since the change in resistance of the superconductor from normal to the superconducting state is extremely large and sharp and can be measured accurately to levels better than 10⁻⁹ ohms. The measurement can be taken on demand, continuously or periodically with very low consumption of the cryogen, fast response and stability since the sensor element is thin and continuous.

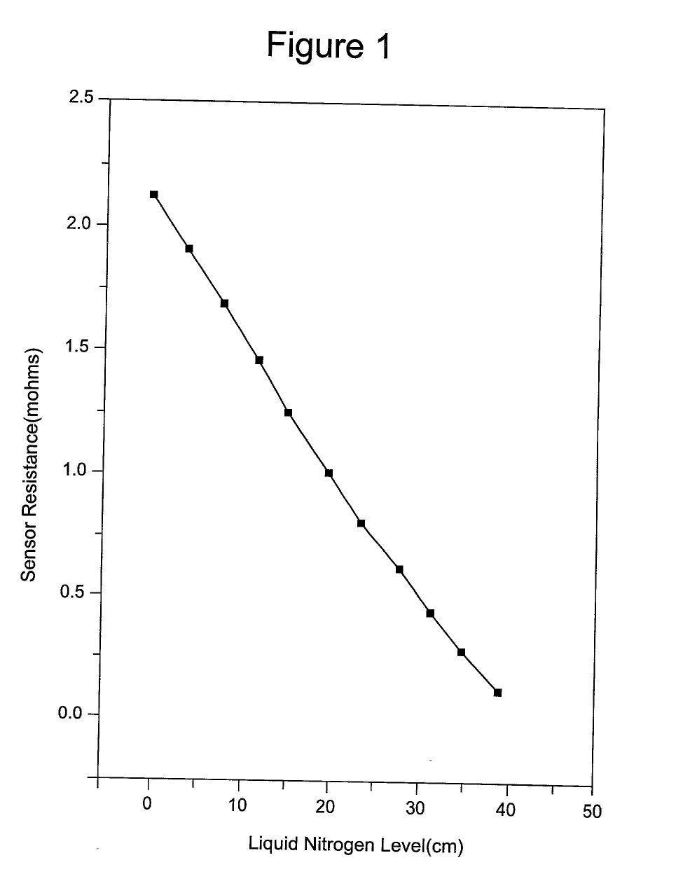

The use of liquid nitrogen level sensor-monitor device of the invention to measure the liquid nitrogen level in a cryocan is depicted schematically in FIG. 1. The sensor element (1) is encapsulated in a thin layer of silver (2) (silver based alloy may also be used). The encapsulated sensor element is fixed on a cryostable fiber reinforced plastic strip (3) (materials such as epoxy can be used to form the strip) by means of a cryostable adhesive. Any converntional cryostable adhesive may be used to affix the encapsulated sensor element to the plastic strip. A resistance measuring means comprising four terminals (4,4′ and 5,5′) is provided on the encapsulated sensor element. Terminals (4,4′) comprise the current terminals are connected to a current source (6) by means of leads (7). Terminals (4,4′) are provided on the respective ends of the encapsulated sensor element (1). Terminals (5,5′) comprise the voltage terminals and are connected to a sensitive voltmeter (6′) by means of leads (8). Terminals (5,5′) are provided on the inside of the encapsulated sensor element (1), generally about 1 cm from the respective ends of the encapsulated sensor element. The entire assembly is dipped in a cryocan (10) containing liquid nitrogen. To determine the level of liquid nitrogen in the cryocan, constant current is applied by current source (6) across terminals (4,4′) provided on the encapsulated sensor element (1) and the voltage measured across terminals (5,5′) by voltmeter (6′). Since portion of the encapsulated sensor element in the liquid nitrogen in the cryocan becomes superconducting, the resulting resistance gives a measure of the portion of the element above liquid nitrogen thus providing a measure of the level of the liquid nitrogen left in the cryocan.

The sensor element is prepared by powder in tube (TIT) technique described in copending Indian application No. 2370/Del/95 and 259/DEL/97 which are incorporated herein by reference. The method for the manufacture of liquid nitrogen level sensing-monitoring device comprises packing a highly reactive precursor powder free from carbon in high purity seamless silver tubes, end sealing the silver tubes containing the precursor, repeatedly groove rolling and annealing the silver tubes to form silver sheathed wires, repeatedly flat rolling and annealing the wires to form silver sheathed tapes, repeatedly flat rolling and heat treating the tapes at a temperature in the range of 810 to 840° C. in an oxidising atmosphere for a period in the range of 100 to 150 hours to obtain silver sheathed mono layer superconducting tape. The monolayer tapes can stacked and folded in silver sheets of high purity and then repeatedly annealed and flat rolled to form multilayered tapes which are then heat treated at a temperature in the range of 810 to 840° C. in an oxidising atmosphere for a period in the range of 100 to 150 hours to obtain silver sheathed multilayer superconducting tape. The number of such monolayer tapes stacked are in the range of 5 to 20. The thickness of the multilayer superconducting tape is in the range of 0.25 to 1.5 mm.

The invention will now be explained in greater detail with reference to the following examples, which are illustrative and should not be construed as limiting the scope of the invention.

### EXAMPLE 1

A multifilamentary silver sheathed bismuth based superconducting tape comprising five filaments and having a length of 60 cm was prepared using a powder in tube (TIT) technique (described in copending Indian application No. 2370/Del/95 and 259/DEL/97). The tape was then fixed to a cryostable fiber reinforced plastic strip of size 1 mm×5 mm×600 mm using a cryostable adhesive. Four lead wires were soldered to the tape; two at the ends as current leads and the other two about 1 cm inside from both ends of the tape as the voltage leads for measuring resistance. The current leads were connected to a constant dc current source and the voltage leads to a nanovoltmeter. The sensor element thus made was slowly immersed in a cryocan containing liquid nitrogen up to a level of about 40 cm. The resistance of the sensor element at different depths in liquid nitrogen was measured by passing a constant current of 1 A through the element. A graph between the resistance of the sensor element and the sensor level was plotted. A linear plot as shown in FIG. 2 was obtained. The sensor was then used to monitor the level of liquid nitrogen in a Dewar at different depths both continuously and periodically. An accuracy of better than 1 mm was achieved in all the measurements.

### EXAMPLE 2

The above experiment was repeated using a monofilamentary silver sheathed BSCCO tape of length 50 cm. The fiber reinforced strip used to support the tape was 1 mm×5 mm×500 mm A calibration graph was plotted by immersing the element in a cryocan containing liquid nitrogen up to a level of 30 cms. Again a linear graph was obtained when the resistance of the sensor element was plotted against the sensor level. The sensor was then used to measure the liquid nitrogen level in a Dewar up to a level of 30 cm. The measured levels were found to be in agreement with the actual levels within a limit of±1 mm.

We claim:

1. A liquid nitrogen level sensing-monitoring device comprising a sensor element made of a high temperature conducting material encapsulated in a layer of metal, said encapsulated sensor element being affixed to a cryostable fiber reinforced plastic substrate, said sensor element being provided with a resistance measuring means.

2. A liquid nitrogen level sensing-monitoring device as claimed in claim 1 wherein the sensor element is in the form of a thin tape or filament.

3. A liquid nitrogen level sensing-monitoring device as claimed in claim 1 wherein the sensor element tape comprises a tape made of one or more filaments.

4. A liquid nitrogen level sensing-monitoring device as claimed in claim 1 wherein the high temperature conducting material is selected from BSCCO and YBCO.

5. A liquid nitrogen level sensing-monitoring device as claimed in claim 1 wherein the metal layer comprises a thin layer of silver or a silver based alloy.

6. A liquid nitrogen level sensing-monitoring device as claimed in claim 1 wherein the fiber reinforced substrate comprises a long strip.

7. A liquid nitrogen level sensing-monitoring device as claimed in claim 1 wherein the resistance measuring means comprises a four terminal resistance measuring means, one set of two terminals, each being connected to respective ends of the encapsulated sensor element as the current terminals and the other set of two terminals each being provided on the inside from both ends as the voltage terminals for measuring the resistance.

8. A liquid nitrogen level sensing-monitoring device as claimed in claim 1 wherein the resistance measuring means is connected to a constant current source and a sensitive voltmeter calibrated in terms of liquid nitrogen level.

9. A method for the manufacture of liquid nitrogen level sensing-monitoring device comprising packing a highly reactive precursor powder free from carbon in high purity seamless metal tubes, end sealing the metal tubes containing the precursor, repeatedly groove rolling and annealing the metal tubes to form metal sheathed wires, repeatedly flat rolling and annealing the wires to form metal sheathed tapes, repeatedly flat rolling and heat treating the tapes at a temperature in the range of 810 to 840° C. in an oxidising atmosphere for a period in the range of 100 to 150 hours to obtain metal sheathed mono layer superconducting tape.

10. A method as claimed in claim 9 wherein a plurality of mono layer superconducting tape are stacked and folded in metal sheets of high purity and then repeatedly annealed and flat rolled to form multilayered tapes which are then heat treated at a temperature in the range of 810 to 840° C. in an oxidising atmosphere for a period in the range of 100 to 150 hours to obtain metal sheathed multilayer superconducting tape.

11. A method as claimed in claim 10 wherein the number of monolayer tapes stacked are in the range of 5 to 20.

12. A method as claimed in claim 9 wherein the thickness of the multilayer superconducting tape is in the range of 0.25 to 1.5 mm.

13. A method as claimed in claim 9 wherein the high temperature conducting material is selected from BSCCO and YBCO.

14. A method as claimed in claim 9 wherein the precursor powder comprises a stoichiometry of Bi:Pb:Sr:Ca:Cu of 1.5-1.9:0.3-0.5:1.8-2.3:2-2.5:2.5-3.8.

15. A method as claimed in claim 9 wherein the metal layer comprises a thin layer of silver or a silver alloy.
